(19) United States
(12) Patent Application Publication
(10) Pub. No.: US 2007/0241233 A1
(43) Pub. Date: Oct. 18, 2007

(54) Aircraft seat and carry-on luggage storage system

(76) Inventor: Franklin J. Cona, Longboat Key, FL (US)

Correspondence Address: FRANKLIN J CONA, P.E.;PATENT AGENT, PO BOX 8490, LONGBOAT KEY, FL, 34228, US

(21) Appl. No.: 11/595,267

(22) Filed: Nov. 9, 2006

Related U.S. Application Data
(60) Provisional application No. 60/792,894, filed on Apr. 18, 2006.

(51) Int. Cl. B64D 11/06

(52) U.S. Cl. 244/118.6

(57) ABSTRACT

The invention comprises an elevated passenger seat with an underseat storage region for accessible, reserved, personal, assigned carry-on luggage space. The elevated passenger seats are in a file relationship and a side-to-side relationship. A method of increasing the total carry-on luggage storage volume in an aircraft is disclosed. The method further allows for removal of overhead storage bins and creates a reserved, personal assigned storage region for each individual passenger. The carry-on luggage region can be enclosed on up to three sides to allow access to the carry-on luggage region from only one side or can be open on all four sides to accommodate extra large luggage.

This application is based on Provisional Application U.S. 60/792,894 filed on Apr. 18, 2006, the priority of which is claimed.

### FIELD OF THE INVENTION

The present invention relates to a new and improved airplane seat and in particular to a novel, new carry-on luggage storage system beneath the seat.

### BACKGROUND OF THE INVENTION

Currently, there are two types of aircraft fuselages in commercial passenger service. One is called a narrow body and the second is called a wide-body.

The narrow body usually has only one aisle with a paired row of passenger seats flanking the aisle. In the economy section, the rows are usually arranged in a 3/3 or 3/2 seat configuration. The business or first class section usually has a 2/2 configuration

The economy section in a wide body type usually has two aisles with passenger seats arranged in a left-aisle-middle-aisle-right row arrangement. The left and right most sections usually have a two seat side-by-side configuration. The middle section usually has four seats in a side-by-side configuration.

Storage space on an aircraft is limited due to the shape of the fuselage required to achieve fuel efficiency at the near sonic (Mach 0.9+) speeds that today's' jet aircraft travel. Overhead bins are the primary means of passenger carry-on luggage storage. The overhead storage bins on an aircraft are limited in size due the arcuate shape of the fuselage of the aircraft and the inability to extend the overhead bins over the head of the passenger in the aisle seat. Further, the overhead bins are available to all passengers on a first in basis. Only the severely limited space under the seat in front of a passenger is personal to the passenger.

Narrow body aircraft currently dominate the passenger market. They have a single center aisle with a series of passenger seats arranged in a 3 abreast or 2 abreast configuration flanking the aisle. Overhead storage bins are disposed over the passenger seats. Wide-body aircraft are primarily used for trans-continental and overseas flight of long duration. They usually have two aisles with a series of passenger seats arranged in a 4 abreast or 3 abreast or 2 abreast configuration flanking the aisles. They also have additional overhead storage bins over the middle section, but still the total space allotted to passenger carry-on luggage is not sufficient to meet the demand.

Many passengers are not checking their luggage at the airport due to delays in claiming their luggage at baggage claim and the frustration encountered when the airline loses their luggage. Accordingly, many passengers carrying-on all their luggage and storing it in the overhead storage bins to avoid delays and frustration. Accordingly, those lucky few who board the aircraft first fill the overhead bins with their carry-on luggage and enjoy the area under the seat in front of them for movement of their legs. Those unfortunate passengers who board later must store their carry-on luggage under the seat in front of them and lose the ability to move their legs during the flight. This lack of movement in the legs can cause discomfort and in some cases lead to blood clots in the calf of the legs. During the boarding phase, flight attendants are constantly pleading with passengers to consider their fellow passengers and store one piece of carry-on luggage under the seat to free up space in the overhead bins for those boarding the aircraft later.

There are many inventions drawn to aircraft seats. Heretofore, aircraft seat design has focused on safety, crash resistance and weight reduction. By way of example, U.S. Pat. No. 6,913,227 issued to Mahmulyin discloses a smaller seat for children that are easily interchangeable with a full size passenger seat. Patent '227 is silent on raising the height of a single aircraft seat and converting the space beneath the seat for accessible, dedicated, personal, assigned carry-on luggage space.

U.S. Pat. No. 5,868,472 issued to Grilliot, et al. teaches a seat frame with side rail's and base rails to withstand the Federal Aviation Administration (FAA) seat strength guidelines. Patent '472 is silent on raising the height of a single aircraft seat and converting the space beneath the seat for accessible, dedicated, personal, assigned carry-on luggage space.

U.S. Pat. No. 5,531,404 issued to Marechal discloses an underframe to withstand the deceleration forces under a crash landing scenario. Patent '404 is silent on raising the height of a single aircraft seat and converting the space beneath the seat for accessible, dedicated, personal, assigned carry-on luggage space.

U.S. Pat. No. 5,193,765 issued to Simpson, et al. discloses a seat easily convertible from Business Class to Economy Class. Patent '765 teaches away from a single seat type having a space beneath the seat for dedicated personal assigned carry-on luggage space. Patent '765 is silent on raising the height of a single aircraft seat and converting the space beneath the seat for accessible, dedicated, personal, assigned carry-on luggage space.

U.S. Pat. No. 4,881,702 issued to Slettbak discloses a convertible seat for changing the configuration from a 2 side-by-side to a 3 side-by-side arrangement. Patent '702 teaches away from a single aircraft seat having a space beneath the seat for dedicated personal assigned carry-on luggage space.

U.S. Pat. No. 4,756,502 issued to Eagan discloses an aircraft seat for a flight crew member. The seat has a container 26 beneath the seat and further having all four sides to fully enclose the container 26. Patent '502 also teaches swiveling of the seat for member comfort. Patent '502 teaches away from raising the height of a single aircraft passenger seat and converting the space beneath the seat for accessible, dedicated, personal, assigned passenger carry-on luggage space.

U.S. Pat. No. 4,630,864 issued to Toll discloses a lightweight seat and frame. Patent '864 is silent on raising the height of a single aircraft seat and converting the space beneath the seat for accessible, dedicated, personal, assigned carry-on luggage space.

U.S. Pat. No. 4,281,874 issued to Iwans, et al. discloses an aircraft seat with a rearward facing cantilevered tray table. Patent '874 is silent on raising the height of a single aircraft seat and converting the space beneath the seat for accessible, dedicated, personal, assigned carry-on luggage space.

The invention substantially departs from the conventional design of aircraft seats and provides a novel seat and carry-on luggage storage system. Further, the invention increases the total cubic storage space of the passenger section of an aircraft and creates a reserved, carry-on luggage space for each passenger.

### SUMMARY OF THE INVENTION

The invention comprises an elevated passenger seat with an underseat storage region for accessible, reserved, personal, assigned carry-on luggage space. The passenger seat can be installed flanking the aisle and adjacent a conventional seat or a plurality of conventional seats, as in a narrow body aircraft. The elevated passenger seat can be installed in a file relationship and a side-to-side relationship. The carry-on storage region is reserved to the person sitting immediately behind the seat. The carry-on storage region can be subdivided into a plurality of compartments with a shelf. The shelf is attached in removable communication to the support members with a plurality of fasteners.

The carry-on luggage storage space can be enclosed on up to three sides to allow access to the carry-on luggage storage area from only one side, either the front side or the rear side.

In the wide body aircraft, a plurality of elevated passenger seats is disposed flanking both sides of each aisle. A pair of conventional aircraft seats is disposed adjacent to each elevated passenger seat on a leftmost side and a rightmost side of the fuselage. The carry-on storage region is reserved to the person sitting immediately behind the seat. The carry-on storage region can be subdivided into a plurality of compartments with the shelf. The shelf is attached in removable communication to the support members with a plurality of fasteners.

The invention thus provides a useful way of increasing the total storage space for passenger carry-on luggage in an aircraft and also provides for a carry-on luggage storage region that is personal to an individual passenger.

### DESCRIPTION OF THE DRAWINGS

FIG. 1 is a front elevation of the preferred embodiment of the invention.

FIG. 2 is a side elevation view of the preferred embodiment of the invention.

FIG. 3 is a perspective view of the preferred embodiment of the invention in a three abreast configuration with two conventional aircraft seats.

FIG. 4 is a front elevation view of the preferred embodiment of the invention in a two abreast configuration with a single conventional aircraft seat.

FIG. 5 is a side view of another embodiment of the invention without the skirting to enclose the carry-on luggage storage region.

FIG. 6 is a cross section view of the preferred embodiment of the invention installed flanking both sides of the aisle of a narrow body aircraft.

FIG. 7 is a cross section view of the preferred embodiment of the invention installed flanking only one side of the aisle of a narrow body aircraft.

FIG. 8 is a cross section view of the invention installed flanking both sides of both aisles of a wide body aircraft

FIG. 9 is a cross section view of the invention installed throughout a narrow body aircraft and the overhead storage bins removed.

FIG. 10 is a cross section view of the invention installed throughout a narrow body aircraft and the overhead storage bins removed.

### OBJECT OF THE INVENTION

Therefore, it is an object of this invention to increase the total cubic storage capacity of the passenger area of the aircraft.

It is another object of this invention to create an accessible, personal, and reserved carry-on luggage storage region beneath the seat for passenger luggage.

### DETAILED DESCRIPTION OF THE PREFERRED EMBODIMENT

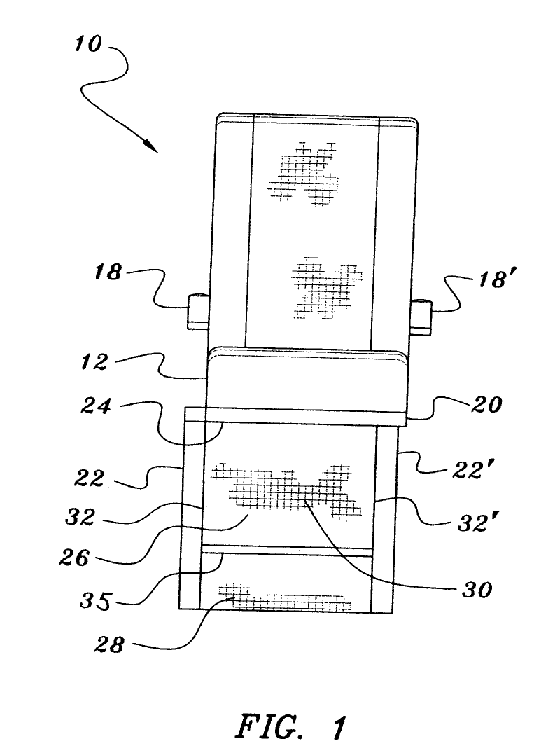

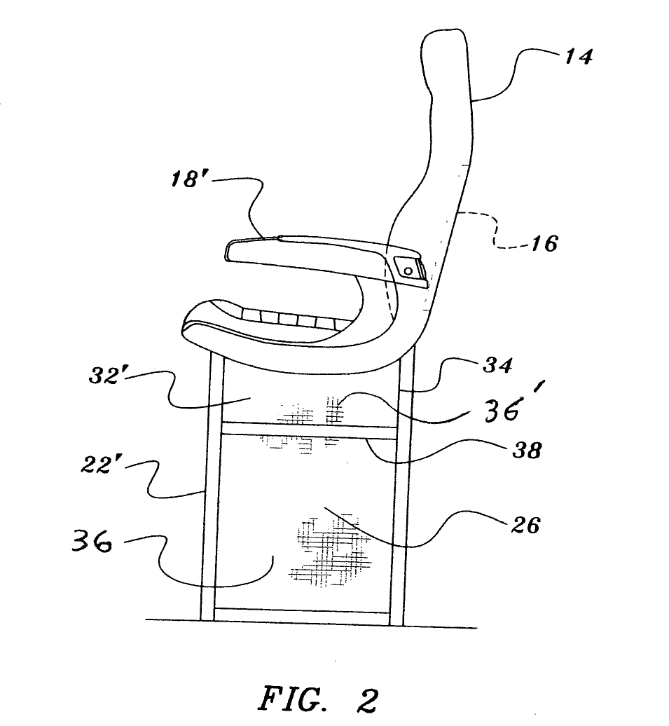

Referring to the drawings and first to FIGS. 1-2, the invention discloses an elevated aircraft seat 10. The seat 10 has a seat bottom 12 and a back 14. The back 14 has a rearward facing tray 16. A plurality of elongated arm rests 18, 18′ are attached to the back 14 in a coplanar, opposed horizontal disposition. A frame 20 is disposed therebeneath the seat bottom 12 and has a plurality of elongated support members 22, 22′ downwardly disposed from an underside 24 of the frame 20. The support members 22, 22′ form a carry-on storage region 26 under the seat 10.

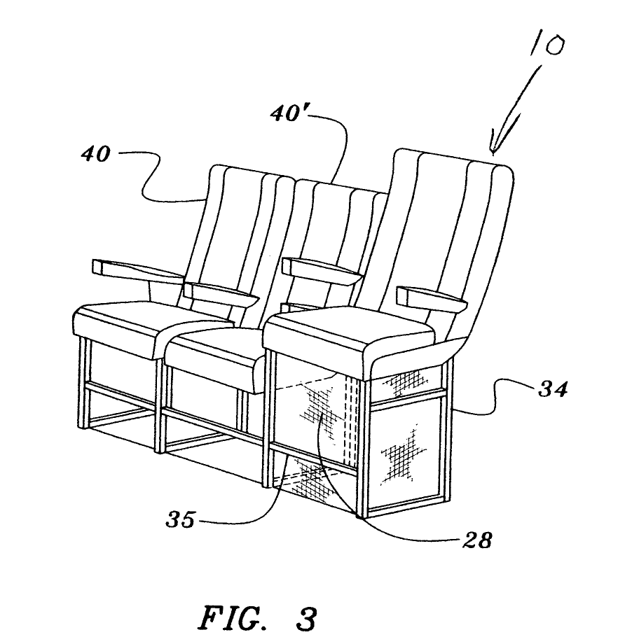

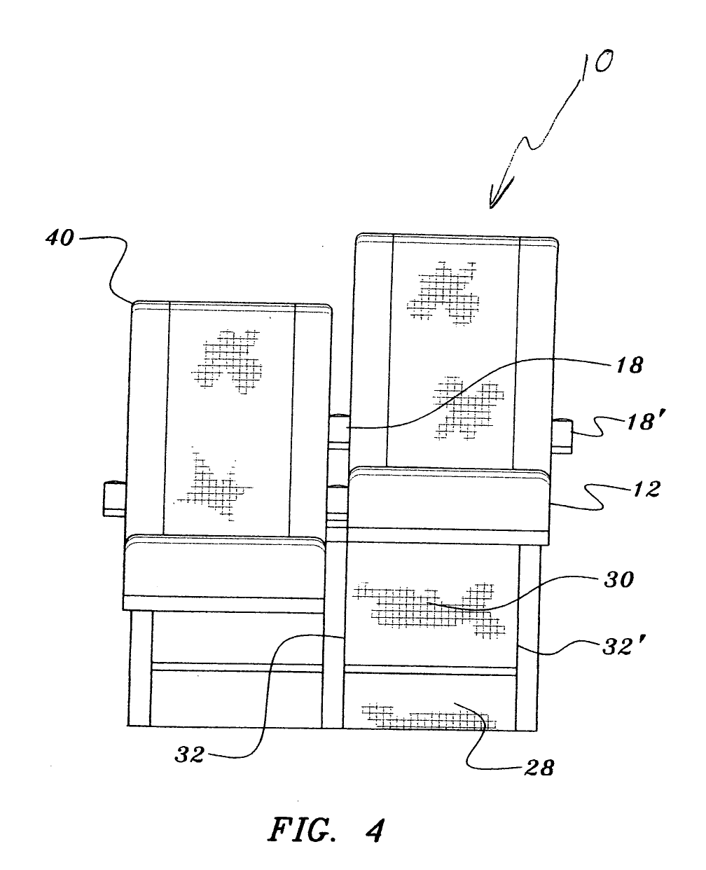

A skirt 28 is disposed on a front side 30 of the carry-on storage region 26 and a pair of opposed skirts 32, 32′ is disposed therebetween the support members 22, 22′ along both sides of the carry-on storage region 26 for enclosing the storage region 26 on three sides and restricting access to only a rear side 34 of the storage region 26. The skirts 28 and 32, 32′ can be made of a rigid or resilient material, preferably resilient as best seen in FIGS. 3-4. A retractable footrest 35 is horizontally disposed between paired support members 22, 22′ for the comfort of the passenger in the seat 10.

The access to the carry-on storage region 26 can be changed to the front side 30 easily by installing the skirt 28 on the rear side 34 of the carry-on storage region 26. Then, the only access to the storage region 26 would be from the front side 30.

The carry-on storage region 26 can be subdivided into a plurality of compartments 36, 36′ with a shelf 38 to accommodate multiple and different size articles; for example a purse, laptop computers and/or a large suitcase. The shelf 38 can be rigid, or alternatively a resilient netting material, preferably netting. The shelf 38 is attached in removable communication to the support members 22, 22′ with a plurality of conventional fasteners.

As best seen in FIG. 3, the seat 10 can be configured with conventional aircraft seats 40, 40′ in a three abreast relationship or a two abreast relationship as best seen in FIG. 4. The conventional seats 40, 40′ are for illustrative purposes only and form no part of this invention.

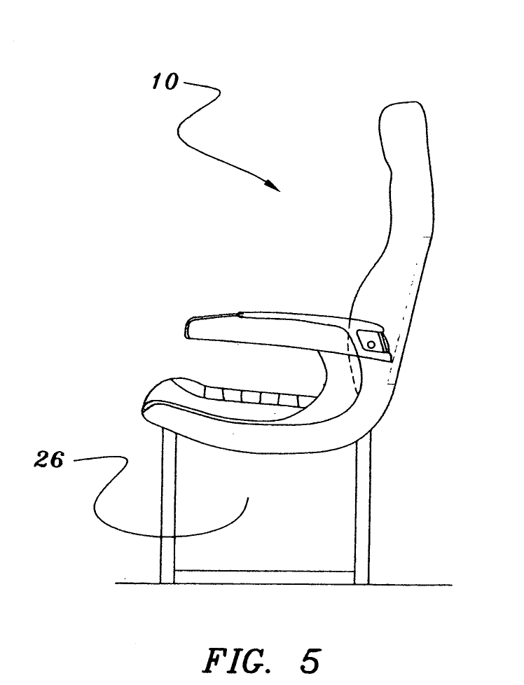

FIG. 5 discloses the seat 10 without the shelf 38 or the skirts 28 and 32, 32′. The carry-on storage region 26 in this embodiment is open on all four sides to allow storage of extra large luggage, for example fishing equipment, golf bags, or musical instruments. The shelf 38 can be positioned to sub divide the carry-on storage region into equal or unequal volumes.

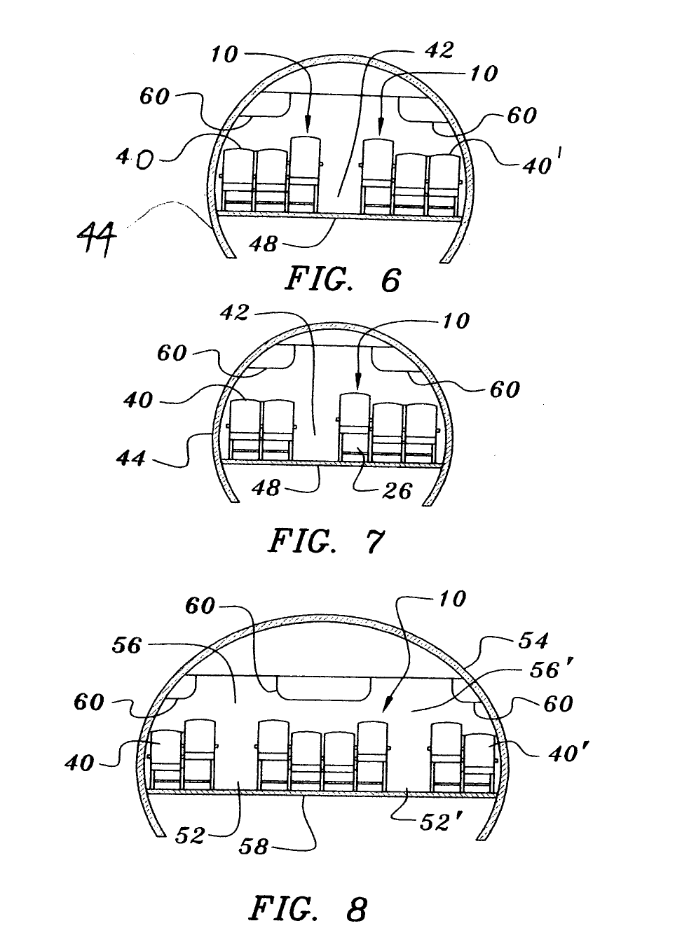

As best seen in FIG. 6, a plurality of seats 10 is disposed flanking both sides of an aisle 42 in a narrow body aircraft fuselage 44. The aircraft fuselage 44 is for illustrative purposes only and forms no part of this invention. A pair of conventional aircraft seats 40, 40′ is disposed adjacent to each seat 10. The conventional seats 40, 40′ are for illustrative purposes only and form no part of this invention. The carry-on storage region 26 is reserved for the person sitting immediately behind the seat 10. The seat 10 is removably attached to a deck 48 of the aircraft fuselage 44 with conventional fasteners.

As best seen in FIG. 7, the seat 10 is deployed on only one side of the aisle 42 in a narrow body aircraft fuselage 44 to form the carry-on storage region 26. The carry-on storage region 26 is reserved to the person sitting immediately behind the seat 10. The opposite side of the aisle 42 employs conventional aircraft seats 40, 40′. The seat 10 is removably attached to the deck 48 of the aircraft fuselage 44 with conventional fasteners.

As best seen in FIG. 8, a plurality of seats 10 is disposed flanking both sides of paired second aisles 52, 52′ in a wide body aircraft fuselage 54. A pair of conventional aircraft seats 40, 40′ is disposed adjacent to each seat 10 on a leftmost side 56 and a rightmost side 56′ and between the innermost seats 10 of the fuselage 54. The carry-on storage region 26 is reserved for the person sitting immediately behind the seat 10. The seat 10 is removably attached to a deck 58 of the aircraft fuselage 54 with conventional fasteners.

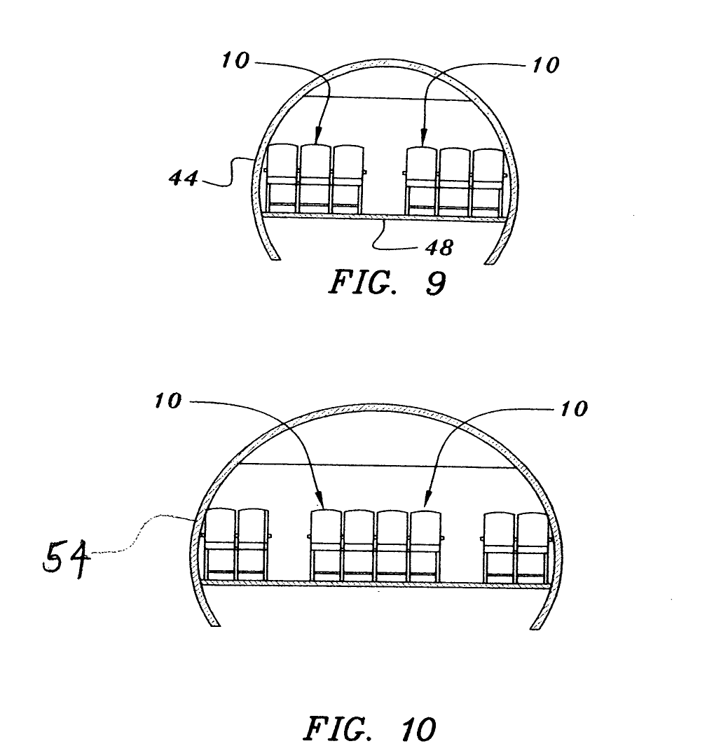

The narrow body fuselage 44 and wide body fuselage 54 have a plurality of overhead carry-on luggage storage bins 60 as best seen in FIGS. 6-7-8. The overhead bins 60 preclude replacing the conventional aircraft seats 40,40′ with a plurality of seats 10 due to the reduction of the ceiling height immediately above the conventional aircraft seat 40,40′. When the overhead bins 60 are removed the conventional aircraft seats 40, 40′ can be replaced with a plurality of seats 10, as best seen in FIG. 9 for the narrow fuselage 44 and FIG. 10 for the wide body fuselage 54.

Now that the invention has been fully described, what is claimed is:

1. An elevated aircraft seat for creating a carry-on luggage storage region beneath the seat for easily accessible, personal, assigned luggage space for use in an aircraft comprising in combination:
a seat bottom;
a seat back;
a tray assembly;
a plurality of arm rests;
a frame therebeneath the seat bottom having a plurality of elongated support members downwardly disposed from an underside of the seat bottom for defining the carry-on luggage storage region; and
said support members in removable communication with a deck of the aircraft.

2. The elevated aircraft seat as claimed in claim 1 and further including a footrest in retractable communication with the frame.

3. The elevated aircraft seat as claimed in claim 1 wherein the frame further includes a skirt disposed between a pair of support members for restricting access to the carry-on luggage storage region from a side of the carry-on storage region

4. The elevated aircraft seat as claimed in claim 3 wherein the frame further includes paired, opposed skirts, each skirt disposed between a pair of support members in an opposed parallel relationship for restricting access to the carry-on luggage storage region from two sides of the carry-on storage region.

5. The elevated aircraft seat as claimed in claim 1 wherein the frame further includes a shelf disposed in the carry-on luggage storage region to subdivide the carry-on storage region into a plurality of sub storage regions, each sub storage region having equal volume.

6. The elevated aircraft seat as claimed in claim 5 wherein the shelf disposed in the carry-on luggage storage region to subdivide the carry-on luggage storage region into a plurality of sub storage regions is fixed to the frame with removable fasteners.

7. The elevated aircraft seat as claimed in claim 1 wherein the frame further includes a shelf disposed in the carry-on luggage storage region to subdivide the carry-on luggage storage region into a plurality of sub storage regions, each sub storage region having unequal volume.

8. The elevated aircraft seat as claimed in claim 4 wherein the skirt and the paired plurality of skirts are disposed between a pair of support members for enclosing three sides of the carry-on luggage storage region and restricting access to the carry-on luggage storage region to only one side.

9. A method of increasing the total carry-on luggage cubic storage volume on a narrow body aircraft comprising the steps of:
removing a plurality of conventional aircraft seats flanking both sides of an aisle; and
installing a plurality of elevated aircraft seats as claimed in claim 1 flanking both sides of the aisle in a single file relationship from the front of the aircraft to the rear of the aircraft.

10. A method of increasing the total carry-on luggage cubic storage volume on a narrow body aircraft comprising the steps of:
removing the overhead bins;
removing all the conventional aircraft seats; and
installing a plurality of elevated aircraft seats as claimed in claim 1 on the airplane in a side-by-side relationship on both sides of an aisle and in a single file relationship from the front of the aircraft to the rear of the aircraft.

11. A method of increasing the total carry-on luggage cubic storage volume on a narrow body aircraft comprising the steps of:
removing a plurality of conventional aircraft seats on only one side of an aisle; and
installing a plurality of elevated aircraft seats as claimed in claim 1 on only one side of an aisle in a single file relationship from the front of the aircraft to the rear of the aircraft.

12. A method of increasing the total carry-on luggage cubic storage volume on a wide body aircraft comprising the steps of:
removing a plurality of conventional aircraft seats flanking both sides of both aisle; and
installing a plurality of elevated aircraft seats as claimed in claim 1 flanking both sides of an aisle in a single file relationship from the front of the aircraft to the rear of the aircraft.

13. A method of increasing the total carry-on luggage cubic storage volume on a wide body aircraft comprising the steps of:
removing the overhead bins;
removing all the conventional aircraft seats; and
installing a plurality of elevated aircraft seats as claimed in claim 1 on the airplane in a side-by-side relationship on both sides of both aisles and in a single file relationship from the front of the aircraft to the rear of the aircraft.
While the invention has been described with a certain degree of particularity it is manifest that many changes may be made in the details of construction and configurations and the arrangement of the invention without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.
